(19) United States
(12) Patent Application Publication
(10) Pub. No.: US 2026/0237229 A1
(43) Pub. Date: Aug. 13, 2026

(54) Machine Learning Based Classification of Cytology Samples from Whole-Slide Images or Cytology Patches

(71) Applicants: Mayo Foundation for Medical Education and Research, Rochester, MN (US); University of Massachusetts, Boston, MA (US)

(72) Inventors: Michael Levy; Neil B. Marya, Worcester, MA (US); Patrick D. Powers, Worcester, MA (US); Rondell P. Graham, Rochester, MN (US)

(21) Appl. No.: 19/152,983

(22) PCT Filed: Feb. 15, 2024
(86) PCT No.: PCT/US2024/016020

§ 371 Date: Aug. 1, 2025

Related U.S. Application Data
(60) Provisional application No. 63/485,459, filed on Feb. 16, 2023.

(51) Int. Cl. G06V 20/69; G06F 18/2433; G06V 10/44; G06V 10/764; G06V 10/82

(52) U.S. Cl. CPC G06V 20/698; G06F 18/2433; G06V 10/454; G06V 10/764; G06V 10/82

(57) ABSTRACT

Computer-aided detection (“CADe”) and/or computer-aided diagnosis (“CADx”) of biliary tract diseases or other pathologies is provided using a machine learning-based analysis of cytology data. In general, a machine learning model-based framework allows cytopathologists to perform a targeted and abbreviated review of select patches extracted from whole-slide images, or in some instances entire whole-slide images, while maintaining interpretive accuracy.

### CROSS-REFERENCE TO RELATED APPLICATIONS

This application claims the benefit of U.S. Provisional Patent Application Ser. No. 63/485,459, filed on Feb. 16, 2023, and entitled “Machine Learning Based Classification of Cytology Samples from Whole-Slide Images or Cytology Patches,” which is herein incorporated by reference in its entirety.

### BACKGROUND

The etiology of biliary strictures is often uncertain given diagnostic challenges, including poor distinction of benign from malignant strictures by imaging, insufficient specimen sampling with brush cytology, and difficult cytologic distinction of reactive epithelial changes from malignancy. The challenges are particularly unique for cholangiocarcinoma (“CCA”), which is an increasingly identified aggressive malignancy of the biliary epithelium that is associated with poor prognosis. Despite high diagnostic specificity (e.g., 98-100%), bile duct brushing cytologic analysis provides low diagnostic sensitivity (e.g., 8-40%), low negative predictive value, and high inter-observer variability even among expert cytopathologists. While the poor sensitivity is aided by use of tumor markers, such as CA 19-9, and enhanced ancillary laboratory techniques such as fluorescence in situ hybridization (“FISH”), there is an unmet need to improve the diagnostic evaluation of biliary strictures.

### SUMMARY OF THE DISCLOSURE

The present disclosure addresses the aforementioned drawbacks by providing a method for classifying cytology patches with a computer system. The method includes accessing cytology data with the computer system, where the cytology data include image patches extracted from whole-slide images of a cytology sample. A neural network is also accessed with the computer system, where the neural network has been trained on training data to classify image patches as being associated with different disease classifications. The cytology data are input to the neural network using the computer system, generating classified feature data as an output. The classified feature data indicate a classification of the image patches in the cytology data as one of the different disease classifications. The classified feature data are presented to a user by the computer system.

It is another aspect of the present disclosure to provide a method for computer-aided diagnosis of whole-slide images of a cytology sample. A whole-slide image is accessed with a computer system, where the whole-slide image depicts a cytology sample. A machine learning model, such as a support vector machine, is accessed with the computer system, where the machine learning model has been trained on training data to classify whole-slide images as being positive or negative for containing a disease condition. The whole-slide image is input to the machine learning model using the computer system, generating whole-slide image (WSI) classified feature data as an output, where the WSI classified feature data indicate whether the whole-slide image is one of positive or negative for containing a disease condition. The WSI classified feature data are presented to a user by the computer system.

The foregoing and other aspects and advantages of the present disclosure will appear from the following description. In the description, reference is made to the accompanying drawings that form a part hereof, and in which there is shown by way of illustration one or more embodiments. These embodiments do not necessarily represent the full scope of the invention, however, and reference is therefore made to the claims and herein for interpreting the scope of the invention.

### BRIEF DESCRIPTION OF THE DRAWINGS

FIG. 1 is a flowchart setting forth the steps of an example method for patch-based classification analysis of cytology data.

FIG. 2 is a flowchart setting forth the steps of an example method for training a machine learning model to classify whole-slide image patches.

FIG. 3 illustrates example whole-slide image patches having been classified as malignant, gray zone, benign, and uninformative.

FIG. 4 illustrates an example of a patch-based classification of whole-slide images that have been identified as malignant or benign.

FIG. 5 is a flowchart setting forth the steps of an example method for whole-slide image classification using a support vector machine trained on summary statistics from an example patch-based classification model.

FIGS. 6A-6H show examples of web-app interface elements for providing computer-aided detection and/or computer-aided diagnosis using the systems and methods described in the present disclosure.

FIG. 7 depicts an example of using occlusion block heatmaps for feature extraction an evaluation.

FIG. 8 is a block diagram of an example cytology data classification system according to embodiments described in the present disclosure.

FIG. 9 is a block diagram of example components that can implement the system of FIG. 8.

### DETAILED DESCRIPTION

Described here are systems and methods for computer-aided detection (“CADe”) and/or computer-aided diagnosis (“CADx”) of biliary tract or other pathologies using a machine learning-based analysis of cytology data. In general, the disclosed systems and methods provide a machine learning model-based framework that allows cytopathologists to perform a targeted and abbreviated review of select patches extracted from whole-slide images, or in some instances entire whole-slide images, while maintaining interpretive accuracy.

In some embodiments, the systems and methods described in the present disclosure provide automated analysis of patches extracted from whole-slide images. As one example, the patches may be extracted from the whole-slide images and used as inputs to a machine learning model that has been trained to classify the patches. The patches may be extracted from the whole-slide images manually, semi-automatically, or automatically. As one non-limiting example, the patches may be extracted by inputting the whole-slide images to a first machine learning model that is trained to extract informative patches from the whole-slide images, and the extracted informative patches are then subsequently input to a second machine learning model that is trained to classify the informative patches. Additionally or alternatively, the whole-slide images may be input to a machine learning model that has been trained to both extract and classify the patches.

In some other embodiments, the systems and methods described in the present disclosure provide analysis of whole-slide images. As an example, the whole-slide images may be input to a machine learning model that has been trained to classify the entire whole-slide image, such as whether the whole-slide image indicates the presence or absence of a particular disease condition. In some instances, a patch-based analysis model can be used to generate the training data used to train a machine learning model used for whole-slide image-based classification.

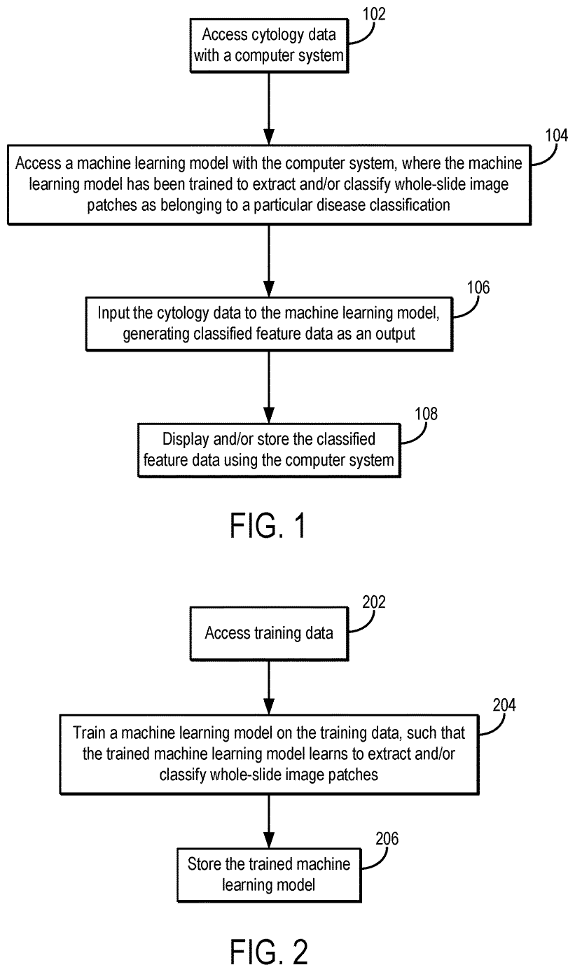

An example of a patch-based analysis model is described with reference to FIGS. 1 and 2. In these instances, one or more machine learning models are used to provide patch-based analyses of cytology data, such as whole-slide images, to mimic pathologist annotation of cytologic patches extracted from whole-slide images.

Referring now to FIG. 1, a flowchart is illustrated as setting forth the steps of an example method for generating classified feature data using a suitably trained machine learning algorithm or model. As will be described, the machine learning algorithm takes cytology data (e.g., biliary duct brushing data) as input data and generates classified feature data as output data. As an example, the classified feature data can be indicative of a disease condition classification and/or a classification of whether the cytology data are informative (e.g., whether subsequent pathologist analysis of the cytology data should be ordered).

The method includes accessing cytology data with a computer system, as indicated at step 102. Accessing the cytology data may include retrieving such data from a memory or other suitable data storage device or medium. Additionally or alternatively, accessing the cytology data may include acquiring such data and transferring or otherwise communicating the data to the computer system.

In general, the cytology data can include cytopathology images. For example, the cytology data can include whole-slide images of a cytology sample. In such instances, acquiring the cytology data can include acquiring cytopathology images with a suitable imaging system, such as a microscopic imaging system, a slide scanner, or the like. The cytology sample depicted in the cytopathology images can be from a biliary duct brushing, or other cytologic biopsy or sampling processes.

In some embodiments, the cytopathology images can include image patches that have been extracted from whole-slide images. In some embodiments, the cytology data accessed with the computer system may include whole-slide images, which may then be subsequently processed to extract one or more patches from the whole-slide images. Patches can be extracted from whole-slide images manually by a user, using a semi-automated process, or using an automated process.

As one non-limiting example, patches can be extracted using one or more filters applied to a whole-slide image. For instance, one or more heuristic filters can be applied to a whole-slide image to extract one or more patches for analysis. A color-based heuristic filter can be applied to remove patches from a whole-slide image that have a limited color variance. The color-based heuristic filter can remove image patches that are predominantly white in color, which indicate little to no stain uptake in those image patches. Additionally or alternatively, the color-based heuristic filter can remove image patches that display an extremely high level of intensity for a particular color, which can indicate regions that were heavily stained, and for which cytologic material may not be visible, may be out of focus, or may otherwise contain little to no cytologic information. As one example, the color-based heuristic filter may be a blue color heuristic filter, such that image patches with little to no blue, or with extremely high blue intensity, will be removed.

In addition to the color-based heuristic filter, an informative heuristic filter can also be applied to a whole-slide image. In some embodiments, the informative heuristic filter can be applied before the color-based heuristic filter. The informative heuristic filter extracts image patches that are predicted to meet or exceed a threshold level of being informative. For instance, image patches that are predicted to be at least 5% informative can be extracted. As a non-limiting example, processing a whole-slide image with an informative heuristic filter can include inputting the whole-slide image to a suitably trained machine learning model, such as a convolutional neural network, to extract the informative patches.

A trained machine learning algorithm or model is then accessed with the computer system, as indicated at step 104. In general, the machine learning algorithm is trained, or has been trained, on training data in order to classify patches of cytology data, such as patches extracted from whole-slide images, as being associated with different disease conditions. For example, the machine learning model can be trained to classify patches extracted from whole-slide images as being associated with one of four classes: malignant, benign, a gray zone (i.e., representing either suspicious or atypical), or uninformative. As one non-limiting example, the classifications can be associated with cholangiocarcinoma (“CCA”), such as whether the patches are associated with malignant CCA, benign CCA, gray zone, or are uninformative. Additionally or alternatively, the classifications can be associated with other diseases, including pancreatic cancer or other biliary duct pathologies. As another example, the machine learning model can be trained to classify patches extracted from whole-slide images as being associated with one of eight classes: WSI positive, patch positive; WSI positive, patch gray zone; WSI positive, patch negative; WSI positive, patch uninformative; WSI negative, patch positive; WSI negative patch gray zone; WSI negative, patch negative; or WSI negative, patch uninformative.

In some embodiments, the trained machine learning model may be implemented as a neural network, such as a convolutional neural network. In these instances, the classifier exampled mentioned above may be referred to as Patch-CNN-4 (i.e., a four class classifier) or Patch-CNN-8 (i.e., an eight class classifier).

An artificial neural network generally includes an input layer, one or more hidden layers (or nodes), and an output layer. Typically, the input layer includes as many nodes as inputs provided to the artificial neural network. The number (and the type) of inputs provided to the artificial neural network may vary based on the particular task for the artificial neural network.

Accessing the trained neural network may include accessing network parameters (e.g., weights, biases, or both) that have been optimized or otherwise estimated by training the neural network on training data. In some instances, retrieving the neural network can also include retrieving, constructing, or otherwise accessing the particular neural network architecture to be implemented. For instance, data pertaining to the layers in the neural network architecture (e.g., number of layers, type of layers, ordering of layers, connections between layers, hyperparameters for layers) may be retrieved, selected, constructed, or otherwise accessed.

The input layer connects to one or more hidden layers. The number of hidden layers varies and may depend on the particular task for the artificial neural network. Additionally, each hidden layer may have a different number of nodes and may be connected to the next layer differently. For example, each node of the input layer may be connected to each node of the first hidden layer. The connection between each node of the input layer and each node of the first hidden layer may be assigned a weight parameter. Additionally, each node of the neural network may also be assigned a bias value. In some configurations, each node of the first hidden layer may not be connected to each node of the second hidden layer. That is, there may be some nodes of the first hidden layer that are not connected to all of the nodes of the second hidden layer. The connections between the nodes of the first hidden layers and the second hidden layers are each assigned different weight parameters. Each node of the hidden layer is generally associated with an activation function. The activation function defines how the hidden layer is to process the input received from the input layer or from a previous input or hidden layer. These activation functions may vary and be based on the type of task associated with the artificial neural network and also on the specific type of hidden layer implemented.

Each hidden layer may perform a different function. For example, some hidden layers can be convolutional hidden layers which can, in some instances, reduce the dimensionality of the inputs. Other hidden layers can perform statistical functions such as max pooling, which may reduce a group of inputs to the maximum value; an averaging layer; batch normalization; and other such functions. In some of the hidden layers each node is connected to each node of the next hidden layer, which may be referred to then as dense layers. Some neural networks including more than, for example, three hidden layers may be considered deep neural networks.

The last hidden layer in the artificial neural network is connected to the output layer. Similar to the input layer, the output layer typically has the same number of nodes as the possible outputs. In an example in which the artificial neural network is a Patch-CNN-4 classifier, the output layer may include four different nodes, where each different node corresponds to a different class. A first node may indicate malignant, a second node may indicate benign, a third node may indicate gray zone, and a fourth node may indicate uninformative. In an example in which the artificial network is a Patch-NCC-8 classifier, the output layer may have eight different nodes corresponding to the eight classes described above. Additionally or alternatively, the output layer may also include nodes outputting other information, such as confidence scores for the classifications, probabilities for the classifications, and so on.

In some instances, the trained machine learning model can be updated via transfer learning, or the like, prior to use. Advantageously, a machine learning model that has been trained as a classifier for one cytologic dilemma can be updated using transfer learning to be applicable for other cytologic dilemmas.

The cytology data are then input to the one or more trained neural networks, generating output as classified feature data, as indicated at step 106. For example, the classified feature data may include classifications for each patch in the cytology data as being associated with a different disease condition class, such as one of the four or eight classes described above, or other suitable classifications of disease condition (e.g., likely malignant, likely benign, etc.). In these instances, the classified feature data can differentiate between different disease conditions.

Additionally or alternatively, the classified feature data may indicate the probability for a particular classification (i.e., the probability that the cytology data include patterns, features, or characteristics indicative of detecting, differentiating, and/or determining the severity of one or more medical conditions). In still other embodiments, the classified feature data may indicate a severity of a disease condition. For example, the classified feature data may include a severity score that quantifies a severity of a disease condition.

Additionally or alternatively, the classifications can be paired with quantitative scores (e.g., confidence scores, probabilities, etc.) associated with the classifications. The classifications can also be provided for particular pathologies, such as cholangiocarcinoma (“CCA”), pancreatic cancer, or other cancer types. For example, the classifications can include “malignant CCA,” “benign CCA,” “indeterminate CCA,” and so on.

In some other embodiments, the classified feature data may include a group of patches extracted from the cytology data (e.g., extracted from whole-slide images contained in the cytology data) that are classified or otherwise identified as being the most relevant patches in the cytology data for subsequent pathologist review. For example, the classified feature data may include a number of patches that are classified or otherwise identified as being informative. In some instances, the classified feature data may also include a proposed diagnostic classification for the patches (e.g., malignant, benign, gray zone), which can be further adjudicated by the pathologist.

The classified feature data generated by inputting the cytology data to the trained neural network(s) can then be displayed to a user, stored for later use or further processing, or both, as indicated at step 108. For instance, the classified feature data can be presented to the user via a user interface generated on a computing device, such as a computer system, tablet, smart phone, or the like. Examples of such user interfaces are described below in more detail. The classified feature data may also be displayed with additional data, such as the original cytology data. For example, the classified feature data may be displayed simultaneously with, or overlaid on whole-slide images and/or image patches. As described above, in some instances the classified feature data may also be stored as training data that can be used to train a whole-slide image classifier, as described below in more detail.

Referring now to FIG. 2, a flowchart is illustrated as setting forth the steps of an example method for training one or more machine learning models on training data, such that the one or more machine learning models are trained to receive cytology data as input data in order to generate classified feature data as output data, where the classified feature data are indicative of classifying patches in the cytology data based on an associated disease condition. In some embodiments, the machine learning model may be implemented as an artificial neural network. In general, such neural network(s) can implement any number of different neural network architectures. For instance, the neural network(s) could implement a convolutional neural network, a residual neural network, or the like. As one non-limiting example, the neural network can use a ResNet architecture, such as a ResNet50 architecture. Alternatively, the neural network(s) could be replaced with other suitable machine learning or artificial intelligence algorithms, such as those based on supervised learning, unsupervised learning, deep learning, ensemble learning, dimensionality reduction, and so on.

The method includes accessing training data with a computer system, as indicated at step 202. Accessing the training data may include retrieving such data from a memory or other suitable data storage device or medium. Alternatively, accessing the training data may include acquiring such data and transferring or otherwise communicating the data to the computer system.

In general, the training data can include input and output pairs of cytology data (e.g., input cytology data and output annotated cytology data that have been annotated by a pathologist). Thus, in some embodiments, the training data may include annotated cytology data that have been annotated (e.g., labeled as containing patterns, features, or characteristics indicative of a disease condition; and the like) by a pathologist.

The method can include assembling training data from cytology data using a computer system. This step may include assembling the cytology data into an appropriate data structure on which the neural network or other machine learning algorithm can be trained. Assembling the training data may include assembling cytology data (e.g., whole-slide images, patches extracted from whole-slide images) and other relevant data. For instance, assembling the training data may include generating annotated cytology data and including the annotated cytology data in the training data. Annotated cytology data may include whole-slide images and/or patches extracted therefrom that have been annotated by a user (e.g., a pathologist) as belonging to, or otherwise being associated with, one or more different classifications or categories. For instance, annotated data may include cytology data that have been labeled as being associated with a disease condition class, such as those described above.

One or more machine learning models (e.g., neural networks or other suitable machine learning algorithms) are trained on the training data, as indicated at step 204. As an example, a neural network can be trained by optimizing network parameters (e.g., weights, biases, or both) based on minimizing a loss function. As one non-limiting example, the loss function may be a mean squared error loss function. As another non-limiting example, in one implementation a convolutional neural network implementing a ResNet50V2 architecture was pre-trained using ImageNet weights and additional training optimized by Nesterov-accelerated Adaptive Moment Estimation Gradient Descent.

Training a neural network may include initializing the neural network, such as by computing, estimating, or otherwise selecting initial network parameters (e.g., weights, biases, or both). During training, an artificial neural network receives the inputs for a training example and generates an output using the bias for each node, and the connections between each node and the corresponding weights. For instance, training data can be input to the initialized neural network, generating output as classified feature data. The artificial neural network then compares the generated output with the actual output of the training example in order to evaluate the quality of the classified feature data. For instance, the classified feature data can be passed to a loss function to compute an error. The current neural network can then be updated based on the calculated error (e.g., using backpropagation methods based on the calculated error). For instance, the current neural network can be updated by updating the network parameters (e.g., weights, biases, or both) in order to minimize the loss according to the loss function. The training continues until a training condition is met. The training condition may correspond to, for example, a predetermined number of training examples being used, a minimum accuracy threshold being reached during training and validation, a predetermined number of validation iterations being completed, and the like. When the training condition has been met (e.g., by determining whether an error threshold or other stopping criterion has been satisfied), the current neural network and its associated network parameters represent the trained neural network. Different types of training processes can be used to adjust the bias values and the weights of the node connections based on the training examples. The training processes may include, for example, gradient descent, Newton's method, conjugate gradient, quasi-Newton, Levenberg-Marquardt, among others.

The artificial neural network can be constructed or otherwise trained based on training data using one or more different learning techniques, such as supervised learning, unsupervised learning, reinforcement learning, ensemble learning, active learning, transfer learning, or other suitable learning techniques for neural networks. As an example, supervised learning involves presenting a computer system with example inputs and their actual outputs (e.g., categorizations). In these instances, the artificial neural network is configured to learn a general rule or model that maps the inputs to the outputs based on the provided example input-output pairs.

In some implementations, an occlusion block heatmap analysis can be used to assess the features or factors relevant to the machine learning model when classifying the cytology data. For instance, an occlusion block heatmap analysis performed in an example study observed that nuclear pleomorphism was implemented as a relevant feature when making malignant/benign predictions.

The one or more trained neural networks are then stored for later use, as indicated at step 206. For example, storing a trained neural network may include storing network parameters (e.g., weights, biases, or both), which have been computed or otherwise estimated by training the neural network on the training data. Storing a trained machine learning model may also include storing the particular model architecture (e.g., neural network architecture) to be implemented. For instance, data pertaining to the layers in a neural network architecture (e.g., number of layers, type of layers, ordering of layers, connections between layers, hyperparameters for layers) may be stored.

In an example study, twenty gold standard biliary duct brushing (“BDB”) whole-slide images (“WSIs”) from 20 patients were selected with the intent of equal proportions of CCA to benign disorders as well as primary sclerosing cholangitis (“PSC”) to non-PSC patients, thereby resulting in 5 CCA with PSC, 5 CCA without PSC, 5 benign strictures with PSC, and 5 benign strictures without PSC. From these 20 WSIs, a total of 30,030 cytologic patches were randomly extracted. Patches were sized to a resolution of 256 by 256 pixels.

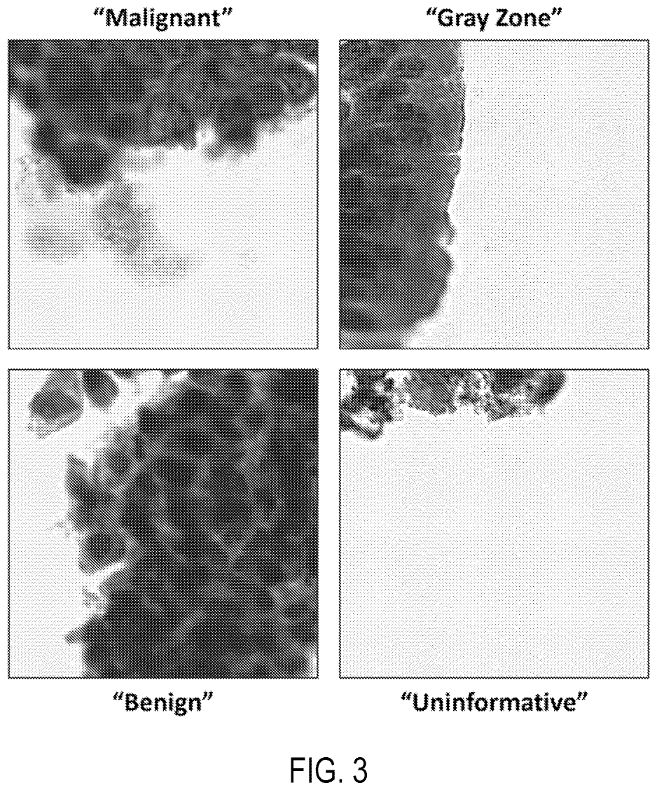

Three expert biliary cytopathologists blindly annotated the 30,030 patches as “malignant,” “gray zone” (representing either suspicious or atypical), “benign,” or “uninformative” (qualitatively and/or quantitatively insufficient material to establish cytologic interpretation) resulting in final database of 90,090 blinded expert annotations. An example of cytologic patches labeled as “malignant,” “gray zone,” “benign,” and “uninformative” by cytopathologist experts is illustrated in FIG. 3. Each patch annotation was based on the most worrisome appearing cell(s). For instance, a patch containing only one malignant appearing cell among many benign appearing cells was considered indicative of a malignant patch.

Annotated patches were randomly assigned on a per-patient basis to either the CNN development cohort (20,528 patches; 22.79%) or CNN test cohort (69,562 patches, 77.21%).

The annotated patches in the training cohort were used to train and evaluate different CNN classification models. Of the models that were evaluated, a ResNet50V2 model (Patch-CNN) was identified as the optimal architecture for this study. The CNN was then pre-trained using ImageNet weights and additional training was then further optimized by Nesterov-accelerated Adaptive Moment Estimation Gradient Descent.

The Patch-CNN was then implemented using TensorFlow2.0 and Keras and a 4-way softmax classification (Patch-CNN-4) output representing the 4 expert annotations the CNN was attempting mimic (i.e., “malignant patch,” “gray zone patch,” “benign patch,” and “uninformative patch”) without considering the underlying WSI diagnosis (i.e., WSI positive or WSI negative).

From the remaining 467 WSI, using Patch-CNN-4 heuristics, all sufficiently informative tiles (i.e., those tiles predicted by the Patch-CNN-4 to be at least 5% informative) were extracted. Subsequently, extracted tiles were then annotated by a combination of the Patch-CNN-4 prediction (i.e., malignant, gray zone, benign, or uninformative) with the underlying WSI diagnosis (i.e., WSI positive or WSI negative).

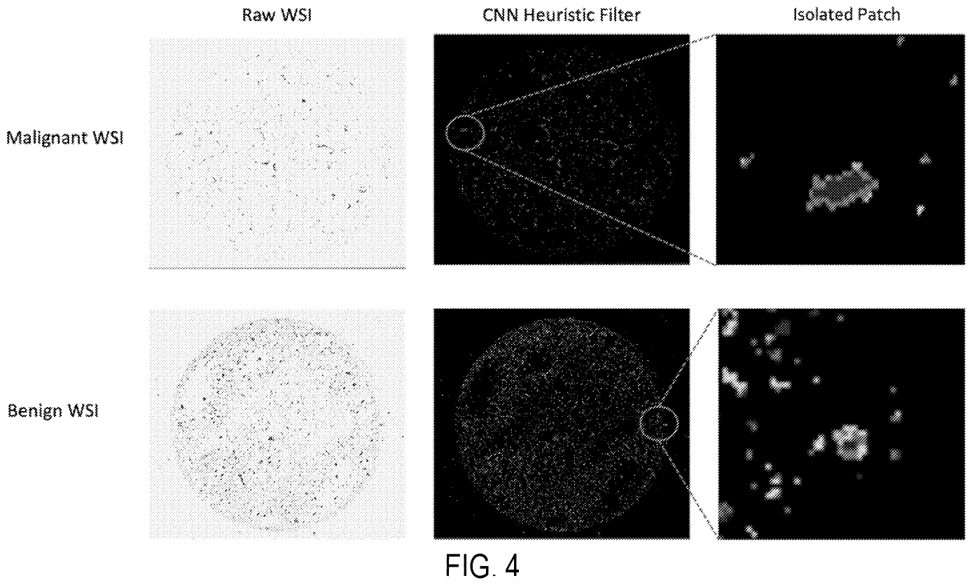

Thus, a second Patch-CNN variant was created with an 8-class softmax output (Patch-CNN-8) representing all possible expert WSI-Patch annotation combinations (i.e., “WSI Positive—Patch Positive,” “WSI Positive—Patch Gray Zone,” “WSI Positive—Patch Negative,” “WSI Positive—Patch Uninformative,” “WSI Negative—Patch Positive,” “WSI Negative—Patch Gray Zone,” “WSI Negative—Patch Negative,” and “WSI Negative—Patch Uninformative.” FIG. 4 illustrates an example demonstrating the application of a Patch-CNN-8-enhanced heuristic filter on malignant and benign WSIs. Areas colored purple correspond to those the CNN predicts annotations to be “uninformative.” Green areas are predicted to be “benign” annotations.” Orange areas are predicted to be “gray zone” annotations. Finally, pink areas are predicted to be annotated as “malignant.”

Consensus annotations were weighted such that annotations agreed upon by more than one expert resulted in double or triple weighting of that patch for training. For the test cohort, patches where all three cytopathologists agreed on interpretation were isolated for CNN evaluation.

The Patch-CNN-4 and Patch-CNN-8 model variants were then configured, trained, and validated. The Patch-CNN-4 variant was trained over 6 frozen epochs and 9 unfrozen epochs after which test performance leveled off. The Patch-CNN-8 variant was trained over 5 frozen epochs and 10 unfrozen epochs after which test performance leveled off.

Receiver operating characteristic (“ROC”) curves demonstrating Patch-CNN-8 performance for the task of predicting expert annotations of cytologic patches originating from positive or negative WSIs were generated for each of the eight possible WSI to Patch interpretations. Areas under the ROC curves (“AUROCs”) and corresponding 95% confidence intervals (95% Cis) were calculated using SciKit-learn V.0.21.3.

Of the 30,030 cytologic patches annotated by the three expert biliary cytopathologists, 297 patches, 4,254 patches, 695 patches, and 9,447 patches had consensus reads (i.e., agreement among all three cytologists) of “positive,” “gray zone,” “negative,” and “uninformative,” respectively. the Patch-CNN-8 performed well identifying patches generated from positive WSIs that the cytopathologists labelled as malignant (i.e., WSI Positive-“Patch Positive”) (AUROC 0.964). The Patch-CNN-8 performance across all 8 possible outputs is demonstrated in Table 1.

TABLE 1
Demonstration of Patch-CNN-8 Annotation Performance

| Classifier | CNN Accuracy |
|---|---|
| WSI Positive - “Patch Positive” | 0.963 |
| WSI Positive - “Patch Gray Zone” | 0.945 |
| WSI Positive - “Patch Negative” | 0.992 |
| WSI Positive - “Patch Uninformative” | 0.686 |
| WSI Negative - “Patch Positive” | 0.806 |
| WSI Negative - “Patch Gray Zone” | 0.922 |
| WSI Negative - “Patch Negative” | 0.909 |
| WSI Negative - “Patch Uninformative” | 0.879 |

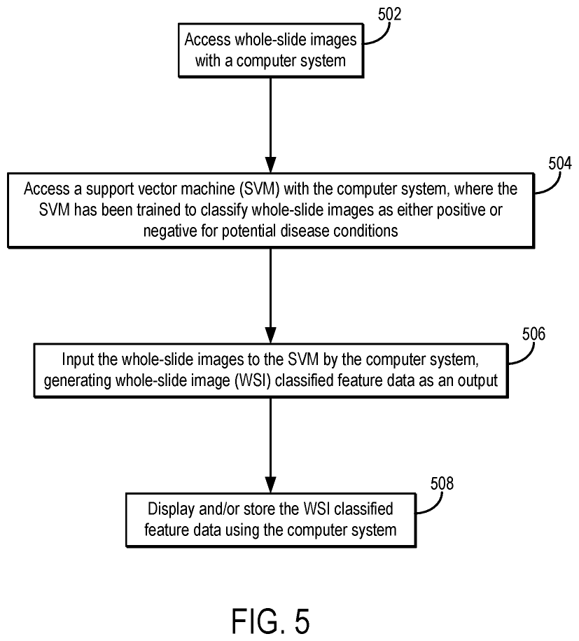

An example of a whole-slide image analysis model is described with reference to FIG. 5. In these instances, one or more machine learning models are used to provide analyses of whole-slide images stored as cytology data to mimic pathologist annotation of whole-slide images. As a non-limiting example, a machine learning model, such as a support vector machine (“SVM”) can be trained to provide a computer-aided diagnosis (“CADx”) tool that can accurately differentiate malignant whole-slide images from benign whole-slide images. In some embodiments, a Patch-CNN, such as those described above, can be used to process whole-slide images for the purpose of creating and validating a SVM for whole-slide image classification (WSI-SVM).

Referring now to FIG. 5, a flowchart is illustrated as setting forth the steps of an example method for generating whole-slide image (“WSI”) classified feature data using a suitably trained SVM or other machine learning algorithm. As will be described, the SVM or other machine learning algorithm takes whole-slide images as input data and generates WSI classified feature data as output data. As an example, the classified feature data can be indicative of a binary classification of the whole-slide image as being either positive (i.e., containing a potential disease condition) or negative (i.e., not containing a potential disease condition).

The method includes accessing whole-slide image data with a computer system, as indicated at step 502. Accessing the whole-slide image data may include retrieving such data from a memory or other suitable data storage device or medium. Additionally or alternatively, accessing the whole-slide image data may include acquiring such data and transferring or otherwise communicating the data to the computer system. For example, whole-slide image data can be acquired with a slide scanner or other suitable imaging system.

A trained SVM (or other suitable machine learning algorithm) is then accessed with the computer system, as indicated at step 504. In general, the SVM is trained, or has been trained, on training data in order to classify whole-slide images as being associated with different binary classifications. For example, the SVM can be trained to classify whole-slide images as being positive or negative for a potential disease condition.

The whole-slide image data are then input to the SVM, generating output as WSI classified feature data, as indicated at step 506. For example, the WSI classified feature data may indicate a binary classification of each whole-slide image, such as whether the whole-slide image is classified as being positive for a potential disease condition, or negative for a potential disease condition.

In general, the computer system receives the whole-slide images as inputs for the SVM. A margin can be defined using combinations of some of the input variables as support vectors to maximize the margin. In some embodiments, a margin can be defined using combinations of more than one of similar input variables. The margin corresponds to the distance between the two closest vectors that are classified differently. For example, the margin corresponds to the distance between a vector representing a first WSI classification (e.g., WSI-Positive) and a vector that represents a second WSI classification (e.g., WSI-Negative). In other embodiments, a single SVM can use a plurality of input variables and define a hyperplane that separates one classification type from other classification types.

The training examples for an SVM include an input vector including values for the input variables, and an output classification indicating whether the whole-slide image belongs to a particular classification (e.g., positive or negative for potential disease). During training, the SVM selects the support vectors (e.g., a subset of the input vectors) that maximize the margin. In some embodiments, the SVM may be able to define a line or hyperplane that accurately separates one classification type from other classification types. In other embodiments (e.g., in a non-separable case), however, the support vector machine may define a line or hyperplane that maximizes the margin and minimizes the slack variables, which measure the error in a classification of an SVM. After the SVM has been trained, new input data can be compared to the line or hyperplane to determine how to classify the new input data (e.g., what classification should be applied to the newly input whole-slide image).

The WSI classified feature data generated by inputting the whole-slide image data to the trained SVM can then be displayed to a user, stored for later use or further processing, or both, as indicated at step 508.

In an example study, the Patch-CNN described above was applied across 467 WSIs for the purpose of creating and validating an SVM for WSI classification (WSI-SVM). Whole-slide images were randomly assigned to training (n=349) or testing (n=118) of the SVM. For patients in the training and/or testing cohort with multiple whole-slide images, all of their assets can be randomized to the same dataset (i.e., train or test). As described previously, for the CADx application, the Patch-CNN-4-derived heuristic filter can first be used to select and eliminate cytologic patches the CNN predicted as predominantly “uninformative.” Additionally, a heuristic filter can also be applied to remove whole-slide image patches with limited blue (or other) color variance, such as predominantly white patches with no stain uptake, or those with extremely high level of blue (or other color) intensity without variation (i.e., those heavily stained areas where cytologic material may not be visible, out of focus, or otherwise containing little cytologic information).

The Patch-CNN-8 described above can then be applied to the sufficiently “informative” patches and patch summary statistics across the entire whole-slide image generated. The patch summary statistics generated from the training and test whole-slide images can be used to develop and then validate an SVM capable of outputting binary whole-slide image classifications of “WSI-Negative” or “WSI-Positive.”

From the 118 biliary duct brushing WSIs in the reserved test set described in the example studies above, 99 test biliary duct brushing WSIs were identified as gold standard WSI-Positive (n=36) or gold standard WSI-Negative (n=63) based on priori criteria and were subsequently used for comparative testing. These 99 WSIs were blindly reviewed by the same expert biliary cytopathologists without access to any clinical, imaging, laboratory, or cytopathology data. The three blinded experts were tasked with labeling each WSI as “positive,” “suspicious,” “atypical,” or “negative.”

CADe and CADx performance were compared to blinded expert review and not to the original, routine cytologic review. Potential confounding information can contribute to official cytology annotations, such as corresponding FISH data, CA 19-9 levels, and prior biliary duct brushing specimen analyses. Thus, in this example study the routine cytologic review was not used as a benchmark for CADe or CADx performance.

For the CADe portion of the study, following a 4-6 month washout period, the blinded cytopathologists re-reviewed the same 99 WSIs. Instead of completely reviewing entire WSIs, they performed a highly limited review of only the 25 highest malignant scoring (i.e., Patch-CNN-8-selected most positive-malignant scoring) patches that were extracted, placed into 99 separate and renumbered folders. The folders were randomly presented to the same blinded cytopathologists who were tasked with providing diagnostic interpretations (“positive,” “suspicious,” “atypical,” or “negative”) based solely on the 25 patches representing each test WSI without access to the remainder of the WSI. Thus, for the CADe evaluation, cytopathologists interpretations were based solely on evaluation of approximately 0.001% of the cytologic material present on a WSI.

For the raw and CADe-assisted phases, interpretations of “positive” were deemed necessary to diagnose a WSI as “positive” for malignancy/neoplasm whereas all other cytologic interpretations (e.g., “suspicious,” “atypical,” and “negative”) were regarded as “negative.” The diagnostic accuracies of raw and CADe review were compared against the WSI-SVM CADx application.

Of the 99 test WSIs meeting gold standard criteria, 36 were positive for malignancy (Table 2). Blinded expert review yielded a sensitivity, specificity, and accuracy of 59.3%, 99.5%, 84.9%, respectively when interpreting without AI assistance. Their collective performance following targeted and abbreviated review of select WSI patches (i.e., only the 25 most worrisome appearing patches as selected by a CNN-generated CADe tool) yielded a sensitivity, specificity, and accuracy of 67.6%, 94.7%, and 84.9%, respectively. (Table 5) In comparison, the WSI-SVM-CADx performance alone was 66.7% sensitive, 90.5% specific, and 81.8% accurate. FIG. 5A-B.

TABLE 2
Breakdown of characteristics of gold standard positive
and negative WSI used for comparative testing

| | Gold Standard | | Gold Standard |
|---|---|---|---|
| | Test Positive WSI | | Test Negative WSI |
| Number | 36 | | 63 |
| WSI originating from | 7 | | 40 |
| patients with PSC, n (%) | (19.4) | | (63.5%) |
| Malignant WSI | 36 | | N/A |
| Cholangiocarcinoma, | 27 | | N/A |
| n (%) | (0.75) | | |
| PSC/De novo, n (%) | 7 | 20 | N/A |
| | (25.9) | (74.1) | |

| | | |
|---|---|---|
| Pancreatic ductal | 4 | N/A |
| adenocarcinoma, n (%) | (11.1) | |
| Metastatic - Colorectal | 3 | N/A |
| adenocarcinoma, n (%) | (8.3) | |
| Ampullary | 2 | N/A |
| adenocarcinoma, n (%) | (5.6) | |

Initial routine cytology impression

| | | |
|---|---|---|
| Positive, n (%) | 29 | 0 |
| | (80.6) | (0.0) |
| Suspicious, n (%) | 4 | 1 |
| | (11.1) | (1.6) |
| Atypical, n (%) | 3 | 14 |
| | (8.3) | (22.2) |
| Negative, n (%) | 0 | 48 |
| | (0.0) | (76.2) |

FISH results, n (%)

| | | |
|---|---|---|
| Polysomy, n (%) | 35 | 0 |
| | (97.2) | (0.0) |
| Tetrasomy, n (%) | 0 | 0 |
| | (0.0) | (0.0) |
| Trisomy, n (%) | 1 | 18 |
| | (2.7) | (28.6) |
| Diploid, n (%) | 0 | 43 |
| | (0.0) | (68.3) |
| Unavailable, n (%) | 0 | 2 |
| | (0.0) | (3.2) |

Advantageously, the systems and methods described in the present disclosure can be integrated into a clinical workflow as a locally staged workflow process, as a cloud-based service (e.g., a web-based application (“app”)), or combinations thereof. This workflow tool can be implemented in clinical practice to automate screening and prioritization of biliary cytology interpretation in a highly reproducible way, eliminate substantial manual effort, and enhance accuracy.

As a non-limiting example, the CNN app can display whole-slide images in raw or digitized format, present CNN interpreted patches scored from most to least worrisome, toggle between overview and local review, compare pre-app and post-app input to assess impact on interpretation and accuracy, support patch reclassification for continuous model improvement, or combinations thereof. In some implementations, the user interface allows for simultaneously displaying patches and/or overlaying patches, selecting the number of prepopulated patches, presenting patches based on interpretation (e.g., positive, suspicious, etc.) rather than probability scoring, adjusting desired CNN diagnostic threshold and composite probability score, selecting patches for re-review or teaching and scoring of individual cytologic features to subsequently enhance the CNN model, and combination thereof.

Advantageously, the user interface application can function either in association with, or independently to, the CNN models. In this way, any enhancements to the models can be easily updated to again interface with the app.

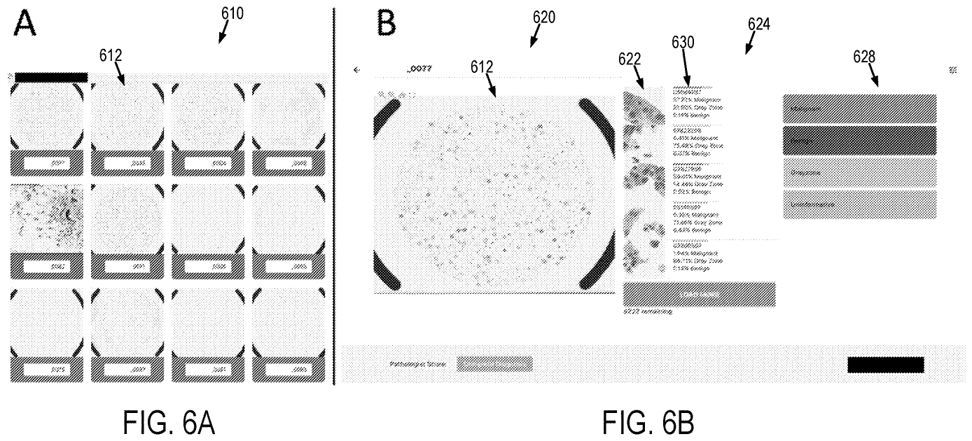

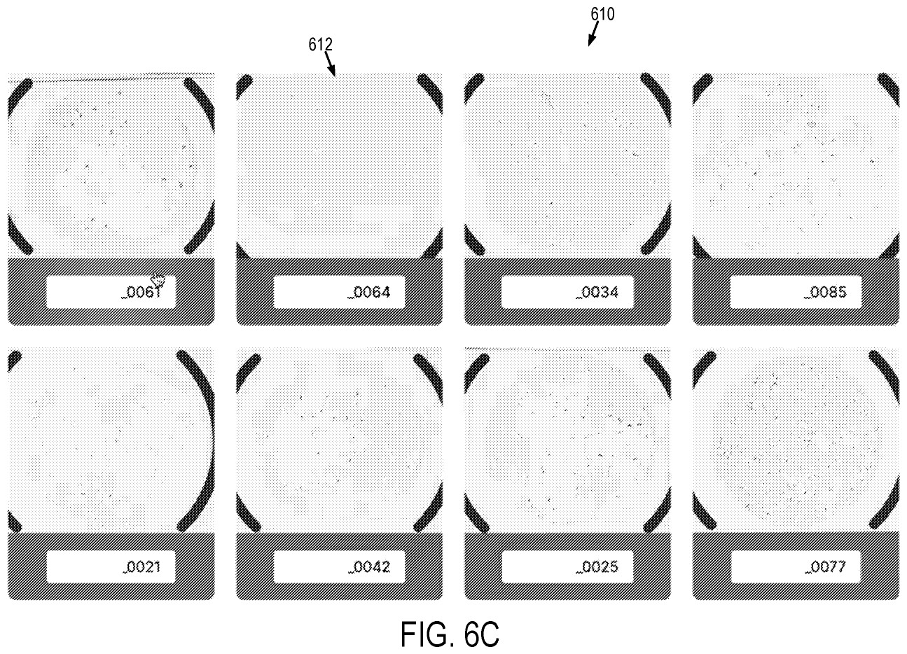

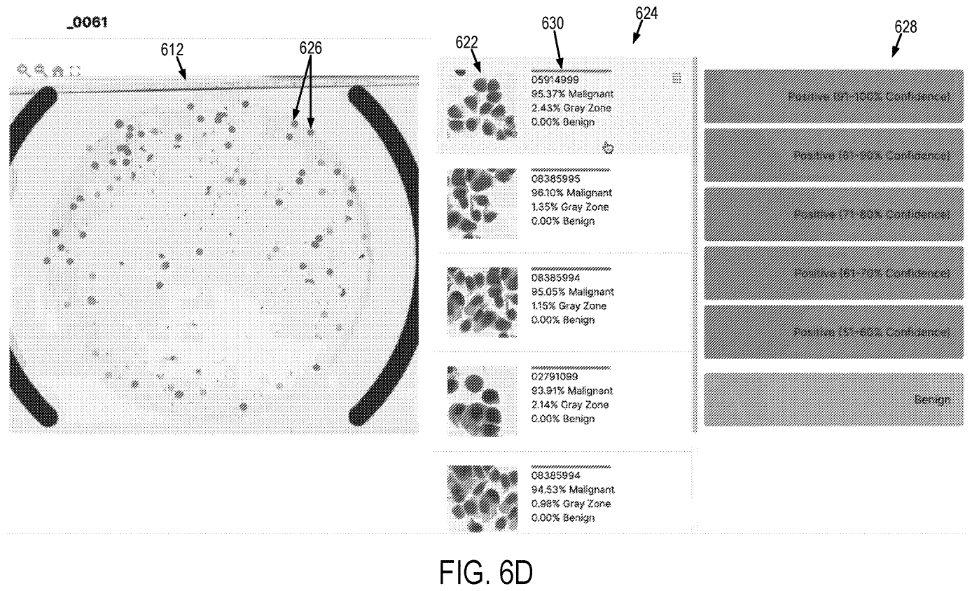

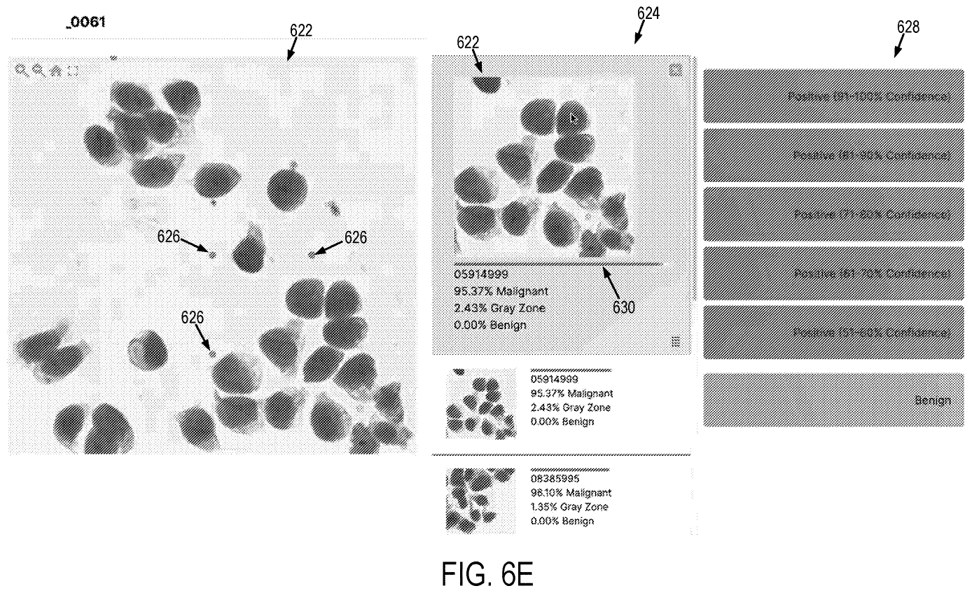

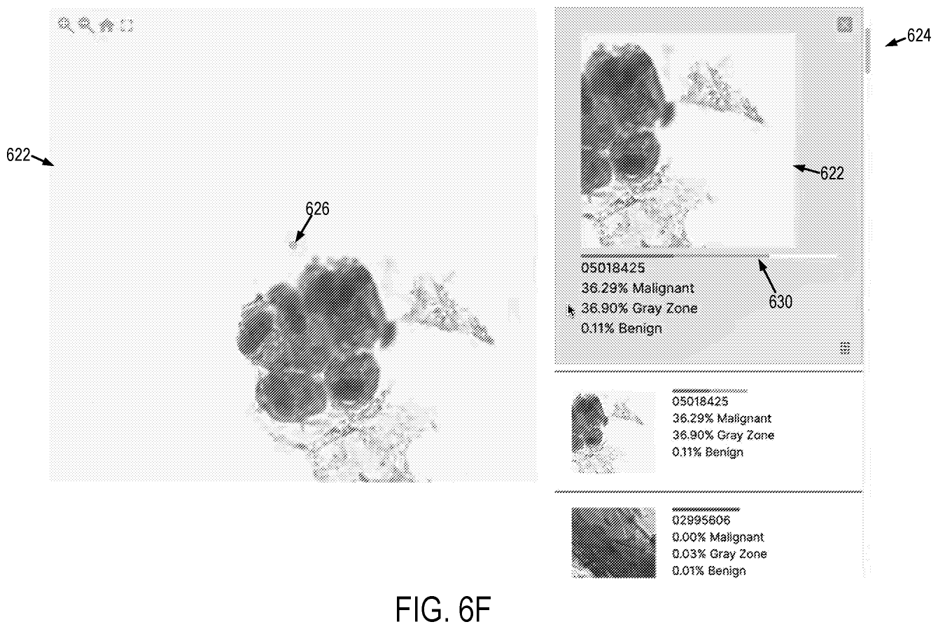

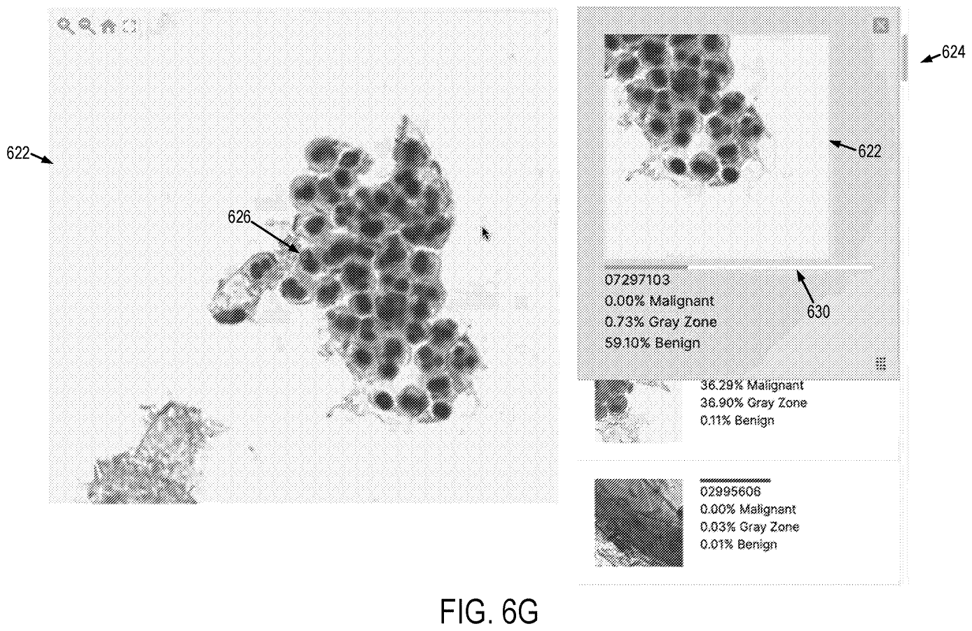

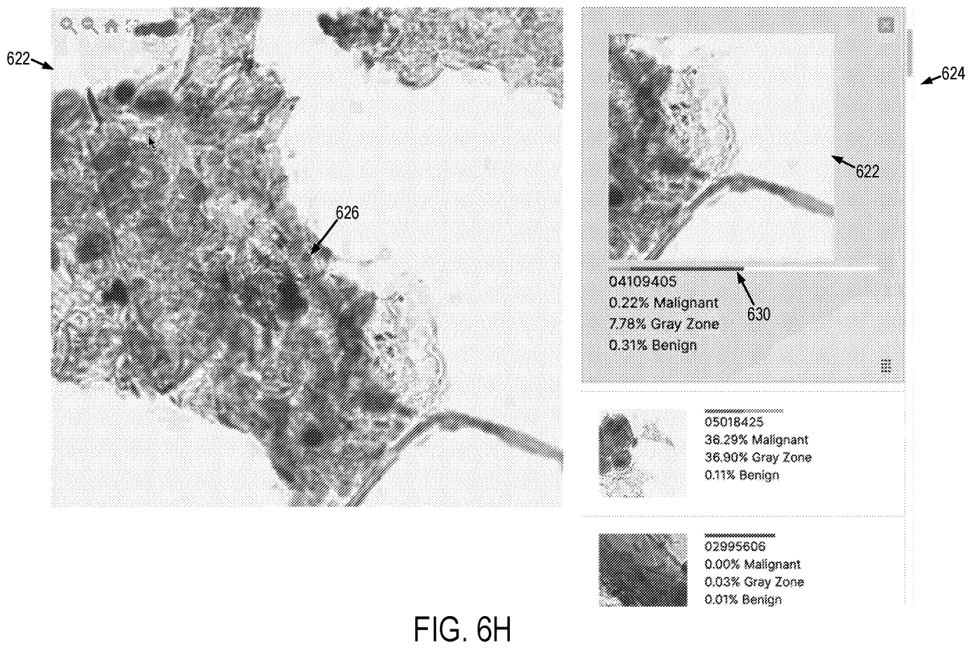

An example web-app interface is shown in FIGS. 6A-6H. FIGS. 6A and 6C illustrate an example worklist view 610 in the app and FIGS. 6B and 6D-6H illustrates an example WSI annotation view 620 in the app.

As shown in FIGS. 6A and 6C, the worklist view 610 presents different WSIs 612 that are available for review by a user. As described above, each WSI 612 can be classified. The classification of each WSI 612 can be displayed as a color coding of the WSI 612. For instance, a red color coding can be used for WSIs 612 classified as being malignant, a green color coding can be used for WSIs 612 classified as being benign, and a gray color coding can be used for WSIs 612 classified as being indeterminate. For instance, WSIs uploaded to the AI-enhanced application can be initially sorted by the CADx. The CADx scores all WSI based on overall likelihood of malignancy. WSIs are highlighted in red if the AI-CADx score exceeds the previously established threshold for malignancy from our prior study. WSIs are highlighted in green if the CADx score is beneath that threshold. On the home page screen, WSIs can be ordered from top to bottom to prioritize WSI by overall risk of malignancy as determined by the CADx.

When a user selects a WSI 612 for annotation, the WSI annotation view 620, as shown in FIGS. 6B and 6D-6H, is presented to the user. The WSI annotation view 620 provides a fully navigable WSI that users can evaluate freely. When a user returns to the worklist view 602 before completing review of a WSI 612, the WSI 612 can be indicated as “in progress” in the worklist view 602, such as by color coding the WSI 612 as yellow, or the like.

In the WSI annotation view 620, the WSI 612 can be displayed to the user together with individual image patches 622 in an image patch list 624. A marker 626 corresponding to each image patch 622 can be overlaid on the WSI 612, indicating the locations on the WSI 612 that correspond to the different image patches 622. These markers 626 indicate “AI hotspots” corresponding to cytologic patches the AI predicts to be likely benign or likely malignant. The WSI annotation view 620 also includes an annotation list 628 of annotations available to the user.

The image patch list 624 can be presented to the user as an AI-prioritized list of concerning cytologic patches. To produce this list, the CADe system processes the entire WSI and then extracts and sorts cytologic patches by likelihood that cellular material in the patch is concerning for malignancy using the techniques described above.

When a user selects an image patch 622 from the image patch list 624 for review, the navigable WSI immediately zooms in on that image patch 622, as illustrated in FIGS. 6B and 6D-6H. Users can then view that patch in the context of the surrounding cytologic material. Once the evaluation of that patch is complete, users score and label the patch based on their concern that malignant cellular material is present. For instance, while an image patch 622 is selected, the user can select a corresponding annotation for that image patch 622 from the annotation list 628. In the illustrated example, the annotations in the annotation list 628 include Positive (91-100% Confidence), Positive (81-90% Confidence), Positive (71-80% Confidence), Positive (61-70% Confidence), Positive (51-60% Confidence), or benign. As shown in FIG. 6B, the annotations may additionally or alternatively include “Malignant,” “Benign,” “Gray Zone,” or “Uninformative.” When the user selects an annotation for an image patch 622, the image patch 622 can be removed from the image patch list 624, thereby allowing the user to systematically work through review of the image patches 622 in the WSI 612. Once user has decided that they have evaluated enough patches and cytologic material, they may also label (or relabel) the WSI as “benign,” “atypical,” “suspicious,” “malignant,” or another classification.

As illustrated, the image patches 622 in the image patch list 624 are indicated with a probability score of belonging to different classifications, such as malignant, gray zone, or benign. Additional, or fewer, classifications may be indicated in the image patch list 624. The classifications and/or probability scores can be presented to the user as textual information (e.g., percent scores), visual information (e.g., a probability score bar 630), or both. As illustrated in FIGS. 6B and 6D-6H, the probability score bar 630 can provide a visual indication of the probability scores for the different classifications of each image patch 622. FIG. 6F illustrates an example where a WSI has been classified as malignant, and the selected image patch 622 is classified as gray zone. FIG. 6G illustrates an example where a WSI has been classified as malignant, and the selected image patch 622 is classified as benign. FIG. 6H illustrates an example where a WSI has been classified as malignant, and the selected image patch 622 is classified as uninformative.

In some examples, the app can include user interface elements that enable filtering of WSIs and/or WSI patches. For example, the app may include filtering for active patch types classified as benign, malignant, or gray zone. In this way, pathologist review can be filtered to only those patches classified by the AI model as being benign, malignant, and/or gray zone. As a result, the user can filter their review to only those patches of interest to them, such as reviewing only malignant patches, reviewing only gray zone patches, reviewing only benign patches, or some combination thereof.

In addition to the above, the AI system and/or the app can track the number of patches users evaluate prior to making a final diagnosis for a slide. The AI system, or app, can also record the amount of time users spend evaluating a WSI prior to making a diagnosis.

The systems and methods described in the present disclosure allow for efficient and comprehensive cytology review. The steps taken for the CNN model and app development provide ready overlap to other disease and specimen types such as pancreas fine needle aspiration (“FNA”) samples and other endoscopic ultrasound FNA specimens.

The model and app are advantageous for biliary cytology interpretation by cytopathologists and can be used for clinical practices with a large volume. By aiding in the timeliness and accuracy of diagnosis, the findings would positively impact the medical care team, and most importantly patients.

In an example study assessing the systems and methods described in the present disclosure for classifying cholangiocarcinoma (“CCA”), 508 biliary duct brushing whole-slide images were generated from 249 consecutive patients from a single center. Twenty of the whole-slide images (10 benign, 10 CCA) were randomly selected, from which 30,000 patches were generated to train and validate a convolutional neural network (“CNN”) model. Three blinded cytologists each annotated the patches (total 90,000 annotations) as “malignant,” “benign,” “gray zone,” or “uninformative.” A ResNet50 architecture was used to train and test the CNN using the annotated patches. Occlusion block heatmap (“OBH”) analysis was used for feature extraction. For whole-slide image analysis, the CNN was applied to all extracted patches from each of the remaining 488 whole-slide images. A final classification model was developed based on CNN outputs. 349 of the remaining whole-slide images were reserved for model training and 139 whole-slide images were reserved for testing by the CNN model and expert, blinded cytologists. A comparative analysis of diagnostic accuracy was performed on 99 whole-slide images from the test cohort with confirmed gold standard diagnoses.

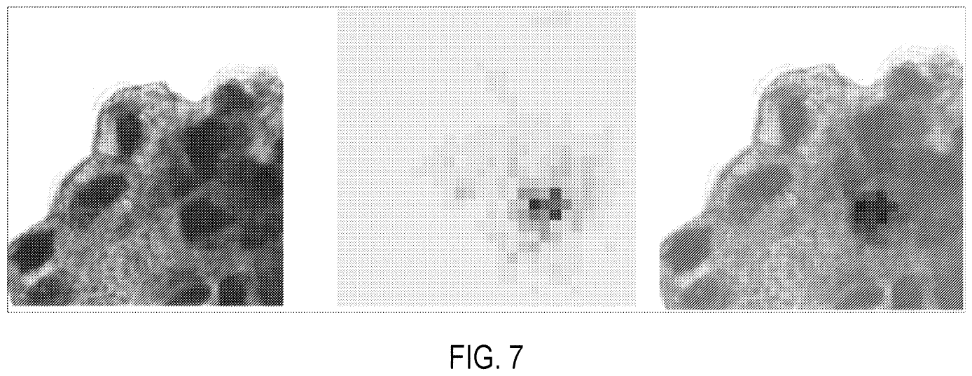

In this example study, the CNN model accurately labeled patches from CCA slides that experts interpreted as “malignant” (AUROC 0.963), “benign” (AUROC 0.992), or “gray zone” (0.945). The model was also accurate in identifying patches from benign slides that experts labelled as “malignant” (AUROC 0.806), “benign” (AUROC 0.909), or “gray zone” (AUROC 0.922). Examples of OBHs highlighting CCA cytologic abnormalities demonstrate that the model identified cytologically relevant features, as shown in FIG. 7. For instance, FIG. 7 demonstrates occlusion heatmap analysis for a cytologic patch containing malignant cells, demonstrating the raw patch (left), the AI-generated heatmap (middle), and a patch overlay (right). The occluded subregions that are purple/blue/green are most relevant to the AI for determining that this patch contains malignant cells. In this example, the CNN identified an area of hyperchromasia as well as an irregularly shaped, enlarged nucleus.

This example study demonstrated that the artificial intelligence-based framework described in the present disclosure was capable of mimicking expert biliary evaluation. The model(s) may be used to generate CNN interpreted patches scored most worrisome to facilitate cytopathologists review, to enhance efficiency, and provide prospective data to assist efforts to enhance model performance.

In another example study, the systems and methods described in the present disclosure were evaluated for cytopathologic interpretation of pancreas fine needle aspiration samples. Pancreatobiliary cytopathology can be challenging, with clinically consequential diagnoses rendered on limited samples. The patch-convolutional neural network artificial intelligence (AI) model described above autonomously interprets biliary brushing cytology specimens. This model can alternatively be trained to interpret pancreas mass fine needle aspiration (FNA) samples.

In an example study, fifty-seven whole slide images (WSI) from 44 patients who underwent pancreas mass FNA were generated from smeared slides and Aperio GT 450 scanners. Twelve samples were positive for malignancy. The AI model made a prediction of the final diagnosis and presented patches from each WSI arranged from most worrisome to least worrisome. Three expert biliary cytopathologists reviewed 5 to 15 patches per WSI in the order provided by the AI model, without clinical information. Each WSI was categorized as “positive”, “suspicious”, “atypical,” or “benign” based on reviewed patches. Diagnostic sensitivity, specificity, and accuracy was calculated for each cytopathologist and the AI model, using the original clinical interpretation as the gold standard. The average time to interpret the patches associated with each WSI was also recorded per cytopathologist and for the AI model.

The AI model had a diagnostic sensitivity, specificity, and accuracy of 76.5% (95% CI 50.1-83.3%), 83.3% (51.6-97.9%), and 79.3% (60.3-92.0%). Cytopathologist review of AI model-selected patches yielded a diagnostic sensitivity, specificity and accuracy of 76.5% (95% CI 62.5-87.2%), 63.9% (95% CI 46.2%-79.2%), and 71.2% (95% CI 60.6-80.5%). The average time to interpret patches from one WSI was 49.9 seconds (range, 33.1-71.1 seconds) for cytopathologists and 45 seconds for the AI model.

This study demonstrated that the AI model had better performance than expert cytopathologists at the case level for this cohort of pancreas mass FNAs. These findings support the increasing promise for a role of AI in assisting with cytopathologic interpretations.

In another example study, the systems and methods described in the present disclosure were evaluated for classifying biliary duct brushing specimens.

Evaluation of biliary duct brushings is a challenging task for cytopathologists. The AI models described in the present disclosure can be used to assist in the reading of biliary duct brushing whole slide images (WSIs).

In an example study, consecutive bile duct brushing WSIs were uploaded to a web-based, AI-enhanced application. The application scores each WSI as “positive” or “negative” for malignancy (CADx). Within each WSI, the AI prioritizes individual cytologic patches by likelihood that a patch contains malignant cytologic material. Using the application, blinded cytopathologists reviewed all WSI and provided interpretations (CADe). Diagnostic accuracy of the CADx, AI-CADe, and the official clinical cytopathologist interpretation (OCI) were compared. To aid in this comparison, a multidisciplinary panel reviewed all relevant information and provided a “gold standard” interpretation for each WSI as being “positive,” “negative,” or “indeterminate.”

Of the 84 WSI uploaded to the AI application, 15 were “positive,” 42 were “negative,” and 17 were “indeterminate” as determined by the multidisciplinary panel. WSIs generated on average 141,950 tiles each. On average users evaluated only 10.6 tiles per WSI, requiring only an average of 84.1 seconds of total WSI evaluation. WSI interpretation accuracy for OCI (0.807; 95% CI 0.671-0.900), CADx (0.754; 95% CI 0.622-0.859), and CADe (0.807; 95% 0.750-0.856) were similar.

This example study demonstrated that the systems and methods described in the present disclosure allow cytopathologists to perform a targeted and abbreviated review of WSIs, while maintaining interpretive accuracy.

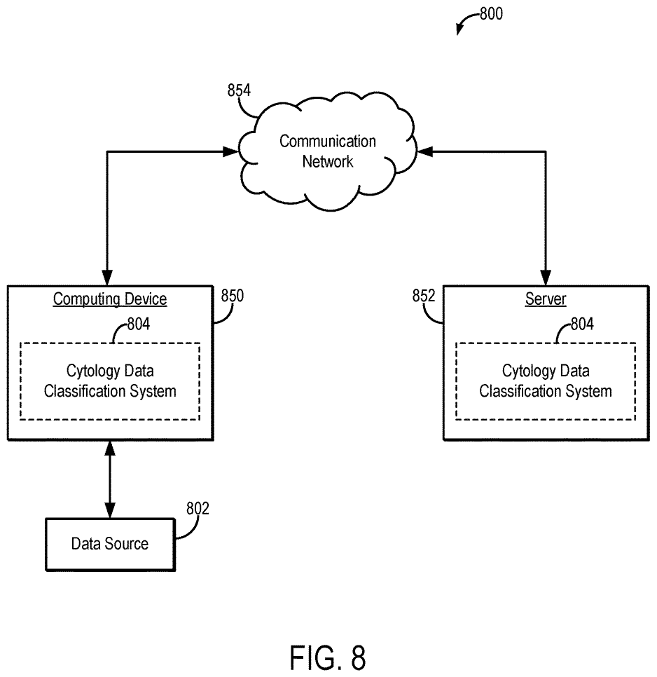

Referring now to FIG. 8, an example of a system 800 for classifying cytology data, such as whole-slide images or patches extracted therefrom in accordance with some embodiments of the systems and methods described in the present disclosure is shown. As shown in FIG. 8, a computing device 850 can receive one or more types of data (e.g., cytology data, whole-slide images, whole-slide image patches, training data) from data source 802. In some embodiments, computing device 850 can execute at least a portion of a cytology data classification system 804 to generate classified feature data from data received from the data source 802.

Additionally or alternatively, in some embodiments, the computing device 850 can communicate information about data received from the data source 802 to a server 852 over a communication network 854, which can execute at least a portion of the cytology data classification system 804. In such embodiments, the server 852 can return information to the computing device 850 (and/or any other suitable computing device) indicative of an output of the cytology data classification system 804. For example, the methods described in the present disclosure can be implemented as a local process (e.g., on a local computing device 850) and/or as a web-based or cloud-based service (e.g., by transmitting data from the computing device 850 to the server 852 for processing, after which the resulting classified feature data and/or associated reports are communicated back to the computing device 850).

In some embodiments, computing device 850 and/or server 852 can be any suitable computing device or combination of devices, such as a desktop computer, a laptop computer, a smartphone, a tablet computer, a wearable computer, a server computer, a virtual machine being executed by a physical computing device, and so on. The computing device 850 and/or server 852 can also reconstruct images from the data.

In some embodiments, data source 802 can be any suitable source of data (e.g., whole-slide images, patches extracted from whole-slide images, other cytology data, or other relevant data), such as a slide scanner or other imaging system, another computing device (e.g., whole-slide images, patches extracted from whole-slide images, other cytology data, or other relevant data), and so on. In some embodiments, data source 802 can be local to computing device 850. For example, data source 802 can be incorporated with computing device 850 (e.g., computing device 850 can be configured as part of a device for measuring, recording, estimating, acquiring, or otherwise collecting or storing data). As another example, data source 802 can be connected to computing device 850 by a cable, a direct wireless link, and so on. Additionally or alternatively, in some embodiments, data source 802 can be located locally and/or remotely from computing device 850, and can communicate data to computing device 850 (and/or server 852) via a communication network (e.g., communication network 854).

In some embodiments, communication network 854 can be any suitable communication network or combination of communication networks. For example, communication network 854 can include a Wi-Fi network (which can include one or more wireless routers, one or more switches, etc.), a peer-to-peer network (e.g., a Bluetooth network), a cellular network (e.g., a 3G network, a 4G network, etc., complying with any suitable standard, such as CDMA, GSM, LTE, LTE Advanced, WiMAX, etc.), other types of wireless network, a wired network, and so on. In some embodiments, communication network 854 can be a local area network, a wide area network, a public network (e.g., the Internet), a private or semi-private network (e.g., a corporate or university intranet), any other suitable type of network, or any suitable combination of networks. Communications links shown in FIG. 8 can each be any suitable communications link or combination of communications links, such as wired links, fiber optic links, Wi-Fi links, Bluetooth links, cellular links, and so on.

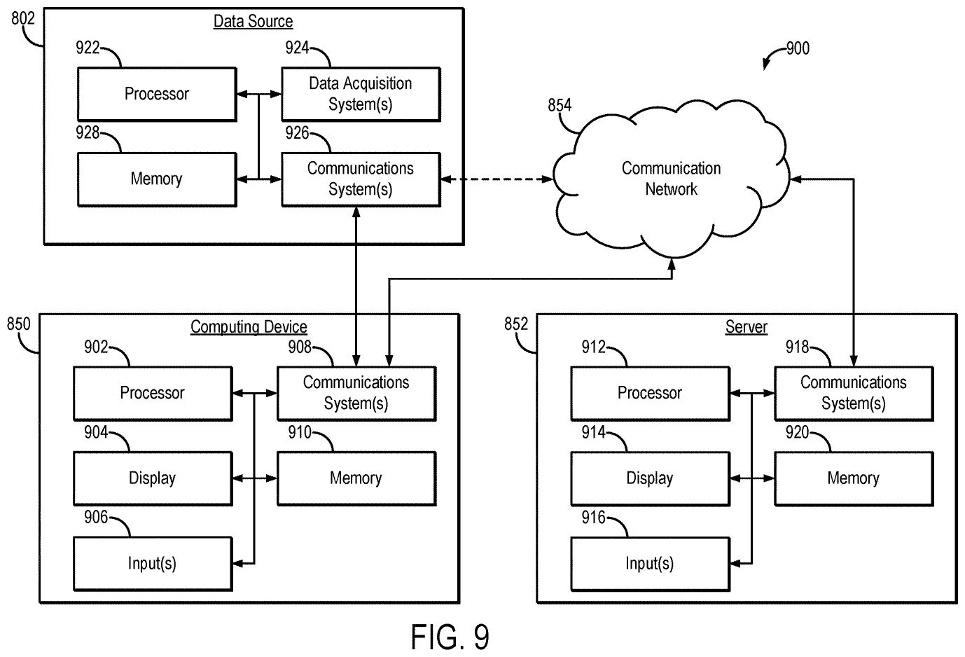

Referring now to FIG. 9, an example of hardware 900 that can be used to implement data source 802, computing device 850, and server 852 in accordance with some embodiments of the systems and methods described in the present disclosure is shown.

As shown in FIG. 9, in some embodiments, computing device 850 can include a processor 902, a display 904, one or more inputs 906, one or more communication systems 908, and/or memory 910. In some embodiments, processor 902 can be any suitable hardware processor or combination of processors, such as a central processing unit (“CPU”), a graphics processing unit (“GPU”), and so on. In some embodiments, display 904 can include any suitable display devices, such as a liquid crystal display (“LCD”) screen, a light-emitting diode (“LED”) display, an organic LED (“OLED”) display, an electrophoretic display (e.g., an “e-ink” display), a computer monitor, a touchscreen, a television, and so on. In some embodiments, inputs 906 can include any suitable input devices and/or sensors that can be used to receive user input, such as a keyboard, a mouse, a touchscreen, a microphone, and so on.

In some embodiments, communications systems 908 can include any suitable hardware, firmware, and/or software for communicating information over communication network 854 and/or any other suitable communication networks. For example, communications systems 908 can include one or more transceivers, one or more communication chips and/or chip sets, and so on. In a more particular example, communications systems 908 can include hardware, firmware, and/or software that can be used to establish a Wi-Fi connection, a Bluetooth connection, a cellular connection, an Ethernet connection, and so on.

In some embodiments, memory 910 can include any suitable storage device or devices that can be used to store instructions, values, data, or the like, that can be used, for example, by processor 902 to present content using display 904, to communicate with server 852 via communications system(s) 908, and so on. Memory 910 can include any suitable volatile memory, non-volatile memory, storage, or any suitable combination thereof. For example, memory 910 can include random-access memory (“RAM”), read-only memory (“ROM”), electrically programmable ROM (“EPROM”), electrically erasable ROM (“EEPROM”), other forms of volatile memory, other forms of non-volatile memory, one or more forms of semi-volatile memory, one or more flash drives, one or more hard disks, one or more solid state drives, one or more optical drives, and so on. In some embodiments, memory 910 can have encoded thereon, or otherwise stored therein, a computer program for controlling operation of computing device 850. In such embodiments, processor 902 can execute at least a portion of the computer program to present content (e.g., images, user interfaces, graphics, tables), receive content from server 852, transmit information to server 852, and so on. For example, the processor 902 and the memory 910 can be configured to perform the methods described herein (e.g., the method of FIG. 1, the method of FIG. 2, the method of FIG. 5).

In some embodiments, server 852 can include a processor 912, a display 914, one or more inputs 916, one or more communications systems 918, and/or memory 920. In some embodiments, processor 912 can be any suitable hardware processor or combination of processors, such as a CPU, a GPU, and so on. In some embodiments, display 914 can include any suitable display devices, such as an LCD screen, LED display, OLED display, electrophoretic display, a computer monitor, a touchscreen, a television, and so on. In some embodiments, inputs 916 can include any suitable input devices and/or sensors that can be used to receive user input, such as a keyboard, a mouse, a touchscreen, a microphone, and so on.

In some embodiments, communications systems 918 can include any suitable hardware, firmware, and/or software for communicating information over communication network 854 and/or any other suitable communication networks. For example, communications systems 918 can include one or more transceivers, one or more communication chips and/or chip sets, and so on. In a more particular example, communications systems 918 can include hardware, firmware, and/or software that can be used to establish a Wi-Fi connection, a Bluetooth connection, a cellular connection, an Ethernet connection, and so on.

In some embodiments, memory 920 can include any suitable storage device or devices that can be used to store instructions, values, data, or the like, that can be used, for example, by processor 912 to present content using display 914, to communicate with one or more computing devices 850, and so on. Memory 920 can include any suitable volatile memory, non-volatile memory, storage, or any suitable combination thereof. For example, memory 920 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 920 can have encoded thereon a server program for controlling operation of server 852. In such embodiments, processor 912 can execute at least a portion of the server program to transmit information and/or content (e.g., data, images, a user interface) to one or more computing devices 850, receive information and/or content from one or more computing devices 850, receive instructions from one or more devices (e.g., a personal computer, a laptop computer, a tablet computer, a smartphone), and so on.

In some embodiments, the server 852 is configured to perform the methods described in the present disclosure. For example, the processor 912 and memory 920 can be configured to perform the methods described herein (e.g., the method of FIG. 1, the method of FIG. 2, the method of FIG. 5).

In some embodiments, data source 802 can include a processor 922, one or more data acquisition systems 924, one or more communications systems 926, and/or memory 928. In some embodiments, processor 922 can be any suitable hardware processor or combination of processors, such as a CPU, a GPU, and so on. In some embodiments, the one or more data acquisition systems 924 are generally configured to acquire data, images, or both, and can include a slide scanner or other digital pathology imaging system. Additionally or alternatively, in some embodiments, the one or more data acquisition systems 924 can include any suitable hardware, firmware, and/or software for coupling to and/or controlling operations of a slide scanner or other digital pathology imaging system. In some embodiments, one or more portions of the data acquisition system(s) 924 can be removable and/or replaceable.

Note that, although not shown, data source 802 can include any suitable inputs and/or outputs. For example, data source 802 can include input devices and/or sensors that can be used to receive user input, such as a keyboard, a mouse, a touchscreen, a microphone, a trackpad, a trackball, and so on. As another example, data source 802 can include any suitable display devices, such as an LCD screen, an LED display, an OLED display, an electrophoretic display, a computer monitor, a touchscreen, a television, etc., one or more speakers, and so on.

In some embodiments, communications systems 926 can include any suitable hardware, firmware, and/or software for communicating information to computing device 850 (and, in some embodiments, over communication network 854 and/or any other suitable communication networks). For example, communications systems 926 can include one or more transceivers, one or more communication chips and/or chip sets, and so on. In a more particular example, communications systems 926 can include hardware, firmware, and/or software that can be used to establish a wired connection using any suitable port and/or communication standard (e.g., VGA, DVI video, USB, RS-232, etc.), Wi-Fi connection, a Bluetooth connection, a cellular connection, an Ethernet connection, and so on.

In some embodiments, memory 928 can include any suitable storage device or devices that can be used to store instructions, values, data, or the like, that can be used, for example, by processor 922 to control the one or more data acquisition systems 924, and/or receive data from the one or more data acquisition systems 924; to generate images from data; present content (e.g., data, images, a user interface) using a display; communicate with one or more computing devices 850; and so on. Memory 928 can include any suitable volatile memory, non-volatile memory, storage, or any suitable combination thereof. For example, memory 928 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 928 can have encoded thereon, or otherwise stored therein, a program for controlling operation of data source 802. In such embodiments, processor 922 can execute at least a portion of the program to generate images, transmit information and/or content (e.g., data, images, a user interface) to one or more computing devices 850, receive information and/or content from one or more computing devices 850, receive instructions from one or more devices (e.g., a personal computer, a laptop computer, a tablet computer, a smartphone, etc.), and so on.

In some embodiments, any suitable computer-readable media can be used for storing instructions for performing the functions and/or processes described herein. For example, in some embodiments, computer-readable media can be transitory or non-transitory. For example, non-transitory computer-readable media can include media such as magnetic media (e.g., hard disks, floppy disks), optical media (e.g., compact discs, digital video discs, Blu-ray discs), semiconductor media (e.g., RAM, flash memory, EPROM, EEPROM), any suitable media that is not fleeting or devoid of any semblance of permanence during transmission, and/or any suitable tangible media. As another example, transitory computer-readable media can include signals on networks, in wires, conductors, optical fibers, circuits, or any suitable media that is fleeting and devoid of any semblance of permanence during transmission, and/or any suitable intangible media.

As used herein in the context of computer implementation, unless otherwise specified or limited, the terms “component,” “system,” “module,” “framework,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

The present disclosure has described one or more preferred embodiments, and it should be appreciated that many equivalents, alternatives, variations, and modifications, aside from those expressly stated, are possible and within the scope of the invention.

1. A method for classifying cytology patches with a computer system, comprising:
(a) accessing cytology data with the computer system, wherein the cytology data comprise images patches extracted from whole-slide images of a cytology sample;
(b) accessing a neural network with the computer system, wherein the neural network has been trained on training data to classify image patches as being associated with different disease classifications;
(c) inputting the cytology data to the neural network using the computer system, generating classified feature data as an output, wherein the classified feature data indicate a classification of the image patches in the cytology data as one of the different disease classifications; and
(d) presenting the classified feature data to a user by the computer system.

2. The method of claim 1, wherein the neural network has three output nodes corresponding to three different disease classifications comprising a malignant classification, a benign classification, and a gray zone classification.

3. The method of claim 1, wherein the neural network has four output nodes corresponding to four different disease classifications comprising a malignant classification, a benign classification, a gray zone classification, and an uninformative classification.

4. The method of claim 3, wherein the classified feature data indicate for each image patch a percentage score for each of the malignant classification, the benign classification, the gray zone classification, and the uninformative classification for that image patch.

5. The method of claim 1, wherein the classified feature data indicate a whole-slide image classification in addition to the classification of the image patches of that whole-slide image.

6. The method of claim 5, wherein the neural network has eight output nodes corresponding to eight different disease classifications comprising a whole-slide image (WSI)-positive malignant classification, a WSI-positive gray zone classification, a WSI-positive benign classification, a WSI-positive uninformative classification, a WSI-negative malignant classification, a WSI-negative gray zone classification, a WSI-negative benign classification, and a WSI-negative uninformative classification.

7. The method of claim 1, wherein the neural network is a convolutional neural network.

8. The method of claim 1, wherein the different disease classifications indicate at least a malignant cholangiocarcinoma (CCA) or a benign CCA classification of each image patch.

9. The method of claim 8, wherein the cytology sample comprises a biliary duct brushing sample.

10. The method of claim 1, wherein the cytology data comprise whole-slide images and accessing the cytology data with the computer system comprises:
accessing the cytology data with the computer system; and
processing the cytology data to extract the image patches from the whole-slide images.

11. The method of claim 10, wherein processing the cytology data to extract the image patches comprises applying at least one heuristic filter to the whole-slide images to extract the image patches.

12. The method of claim 11, wherein the at least one heuristic filter comprises a first heuristic filter and a second heuristic filter, wherein the first heuristic filter comprises a color variance filter that discards image patches with color variance below a threshold amount and the second heuristic filter comprises an informative filter that extracts image patches predicted to exceed a threshold level of being informative for classification.

13. The method of claim 12, wherein the color variance filter is a blue variance filter that discards image patches having limited blue variance.

14. The method of claim 12, wherein the second heuristic filter is implemented as a convolutional neural network that has been trained on training data to predict an image patch's level of being informative for classification.

15. A method for computer-aided diagnosis of whole-slide images of a cytology sample, comprising:
(a) accessing a whole-slide image with a computer system, the whole-slide image depicting a cytology sample;
(b) accessing a machine learning model with the computer system, wherein the machine learning model has been trained on training data to classify whole-slide images as being positive or negative for containing a disease condition;
(c) inputting the whole-slide image to the machine learning model using the computer system, generating whole-slide image (WSI) classified feature data as an output, wherein the WSI classified feature data indicate whether the whole-slide image is one of positive or negative for containing a disease condition; and
(d) presenting the WSI classified feature data to a user by the computer system.

16. The method of claim 15, wherein the machine learning model is a support vector machine (SVM) model.

17. The method of claim 16, wherein the SVM model has been trained on training data comprising annotated whole-slide image patches.

18. The method of claim 17, wherein the annotated whole-slide image patches are generated by inputting unannotated whole-slide image patches to a patch-based convolutional neural network that has been trained on patch training data to classify whole-slide image patches as being associated with different disease classifications.

19. The method of claim 15, wherein:
the machine learning model has additionally been trained on the training data to classify images patches of whole-slide images as being associated with four different disease classifications comprising a malignant classification, a benign classification, a gray zone classification, and an uninformative classification; and
the WSI classified feature data further indicate image patches in the whole-slide image as being associated with one of the malignant classification, the benign classification, the gray zone classification, or the uninformative classification.
